(19) United States
(12) Patent Application Publication
(10) Pub. No.: US 2016/0348385 A1
(43) Pub. Date: Dec. 1, 2016

(54) Multi-Story Residential Building

(71) Applicant: Bruno Bottarelli, Naperville, IL (US)

(72) Inventor: Bruno Bottarelli, Naperville, IL (US)

(21) Appl. No.: 15/166,459

(22) Filed: May 27, 2016

Related U.S. Application Data
(60) Provisional application No. 62/166,840, filed on May 27, 2015.

(51) Int. Cl. E04H 1/04; E04H 6/42; E04H 6/08

(52) U.S. Cl. CPC E04H 1/04; E04H 6/08; E04H 6/426; B66B 9/00

(57) ABSTRACT

A multi-story residential building complex. The building complex includes two ground floor single-story units that each have a front facing entry directly accessing each unit. The building complex further includes up to four second floor units that each have direct stair or elevator access from their ground floor entries. Each building has a front facing the street and a back with a garage unit having one or more parking spaces facing the alley. This configuration allows occupants direct access to their units without the need for common access ways, while simultaneously allowing for improved support for increased population density within a residential area. The present multi-story housing building eliminates the high initial and operating costs of common areas and provides an efficient and economical alternative to current building types.

### CROSS REFERENCE TO RELATED APPLICATIONS

This application claims the benefit of U.S. Provisional Application No. 62/166,840 filed on May 27, 2015. The above identified patent application is herein incorporated by reference in its entirety to provide continuity of disclosure.

### BACKGROUND OF THE INVENTION

The present invention relates to building arrangements. More particularly, the present invention relates to residential building complexes designed to provide increased population density and eliminate the need for common entry areas to each of the individual housing units within the building.

Multi-family residential buildings typically require common areas to provide access to each unit within the building via stairs, elevators, hallways, or any combination thereof. However, common areas carry substantial construction and operational costs that can be prohibitive in meeting market needs. Therefore, there is a need in the prior art for building configurations that lack the prohibitively expensive common areas generally utilized for providing tenants access to their units, while at the same time not sacrificing the amount of livable space available in the residential area.

### SUMMARY OF THE INVENTION

In view of the foregoing disadvantages inherent in the known types of multi-story buildings now present in the prior art, the present invention provides a multi-story building configured to maximize population density and eliminate the need for entryways common to all of the housing units within the building. The present multi-story building comprises two ground floor single story units that each have a front facing entry directly accessing each unit. The building further includes up to four second floor units that each have direct stair or elevator access from their ground floor entries. Each building has a front facing the street and a back with garages facing the alley. This configuration allows occupants direct access to their units without the need for common access ways, while simultaneously allowing for improved support for increased population density within an area. The present multi-story housing building eliminates the high initial and operating costs of common areas and provides an efficient and economical alternative to current building types.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the front of a diagram of an illustrative embodiment of the present multi-story building.

FIG. 2 shows a perspective view of the rear of a diagram of an illustrative embodiment of the present multi-story building.

FIG. 3 shows a plan view of the first floor of a diagram of an illustrative embodiment of the present multi-story building.

FIG. 4 shows a plan view of the second floor of a diagram of an illustrative embodiment of the present multi-story building.

FIG. 5 shows a perspective view of an illustrative embodiment of the present multi-story building.

FIG. 6 shows a plan view of the first floor of an illustrative embodiment of the present multi-story building.

FIG. 7 shows a plan view of the second floor of an illustrative embodiment of the present multi-story building.

FIG. 8 shows a plan view of the third floor of an illustrative embodiment of the present multi-story building.

FIG. 9 shows an elevational view of the front of an illustrative embodiment of the present multi-story building.

FIG. 10 shows an elevational view of the rear of an illustrative embodiment of the present multi-story building.

FIG. 11 shows an elevational view of the right side of an illustrative embodiment of the present multi-story building.

FIG. 12 shows an elevational view of the left side of an illustrative embodiment of the present multi-story building.

### DETAILED DESCRIPTION OF THE INVENTION

Reference is made herein to the attached drawings. Like reference numerals are used throughout the drawings to depict like or similar elements of the XXX. The figures are intended for representative purposes only and should not be considered to be limiting in any respect.

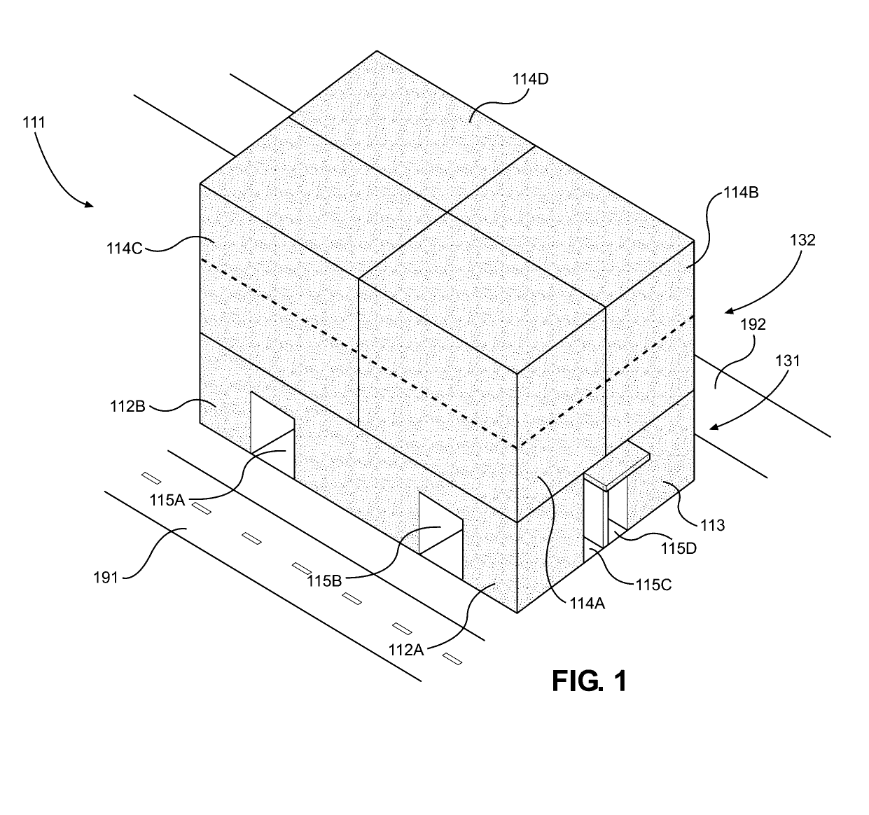

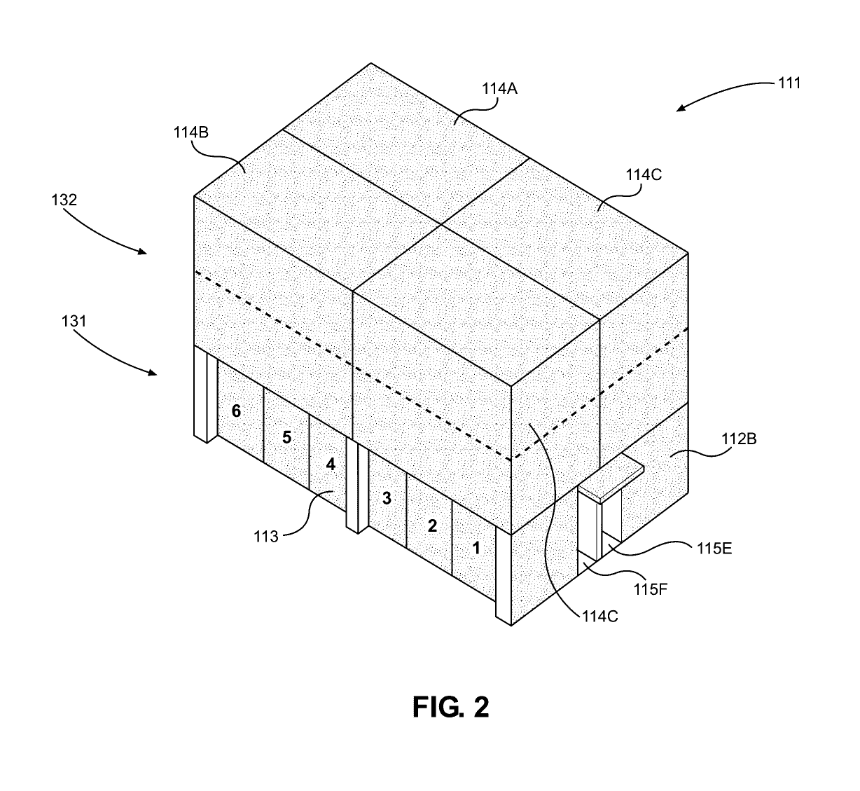

Referring now to FIGS. 1 and 2, there are shown perspective views of the front and the rear of a diagram of an illustrative embodiment of the present multi-story building. The present building 111 includes two one-story units, i.e. flats, disposed on the first level 131 thereof. The one-story units include a first one-story unit 112A and a second one-story unit 112B arranged adjacently to each other. The present building 111 further includes a garage unit 113 arranged adjacently to the first one-story unit 112A and the second one-story unit 112B. The first one-story unit 112A, the second one-story unit 112B, and the garage unit 113 together define the first level 131 of the building 111. The first level 131 has the shape of a closed geometric shape, e.g., a rectangular cuboid.

As used herein, a “garage unit” is enclosed structure having one wall substantially occupied by one or more openable doors to permit access to the interior of the garage unit by a vehicle. The interior of the garage unit can contain one or more spaces in which a vehicle can park. As used herein, a “unit” in the context of a “one-story unit” or a “multi-story unit” is an enclosed structure utilizable as a dwelling by one or more individuals. As used herein, an “access way” is a structure or mechanism for obtaining entry to a unit, e.g., a stairway, an elevator, or a lift.

In one embodiment of the present building 111, the garage unit 113 has a number of spaces equal to the number of dwelling units, i.e., the sum of the number of one-story units 112A, B and the number of multi-story units 114A, B, C, D in the building 111. This arrangement ensures that each tenant has access to a parking space. For example, in the depicted embodiment of the building 111, there are two one-story units 112A, B and four multi-story units 114A, B, C, D; therefore, there are six parking spaces within the garage unit 113. In an illustrative embodiment of the present building 111, the garage unit 113 is equal in height to the one-story units 112A, B situated adjacently thereto, thereby creating a planar or level division between the first level 131 and the second level 132 lying thereover. Furthermore, in an illustrative embodiment of the present building 111, the perimeter of the second level 132 is coextensive with the perimeter of the first level 131 such that the exterior walls of the first and second levels 131, 132 are coplanar.

The present building 111 further includes up to four multi-story units, i.e. townhouses, disposed on the second level 132 thereof. In an illustrative embodiment of the present building 111, the second level 132 includes a first multi-story unit 114A, a second multi-story unit 114B, a third multi-story unit 114C, and a fourth multi-story unit 114D arranged adjacently to each other. Whereas the first level 131 is a single story, the second level 132 has multiple stories as it is made up of multi-story units 114A, B, C, D. Both the second level 132 individually and the combination of the first level 131 with the second level 132 have the shape of a closed geometric shape, e.g., a rectangular cuboid.

The present building 111 further includes a plurality of entries 115A, B, C, D, E, F providing access to the various dwellings or units of which the building 111 is composed. The first entry 115A is disposed on the front of the building 111 and provides access to the first one-story unit 112A. The second entry 115B is likewise disposed on the front of the building 111, separated from the first entry 115A, and provides access to the second one-story unit 112B. A third entry 115C and fourth entry 115D are disposed on a first lateral side of the building 111 and provide access to the first multi-story unit 114A and the second multi-story unit 114B, respectively. A fifth entry 115E and sixth entry 115F are disposed on a second lateral side of the building 111 and provide access to the third multi-story unit 114C and the fourth multi-story unit 114D, respectively.

Within the context of a residential environment, an illustrative embodiment of the building 111 is positioned so that the front of the building 111 is facing a street 191 and the rear of the building 111 is facing an alley 192 extending behind the building 111. The individuals living in the building 111 can access the garage unit 113 located on the rear of the building via the alley 192. A plurality of the present buildings 111 can be arranged adjacently to each other along a common street or road, thereby forming a neighborhood or complex.

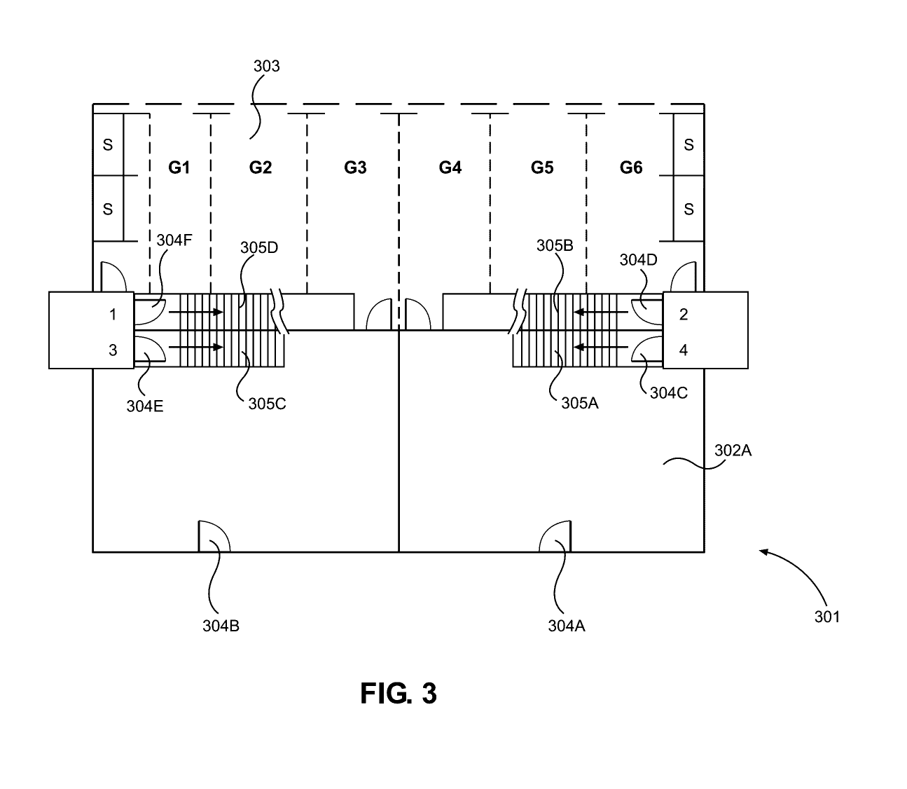

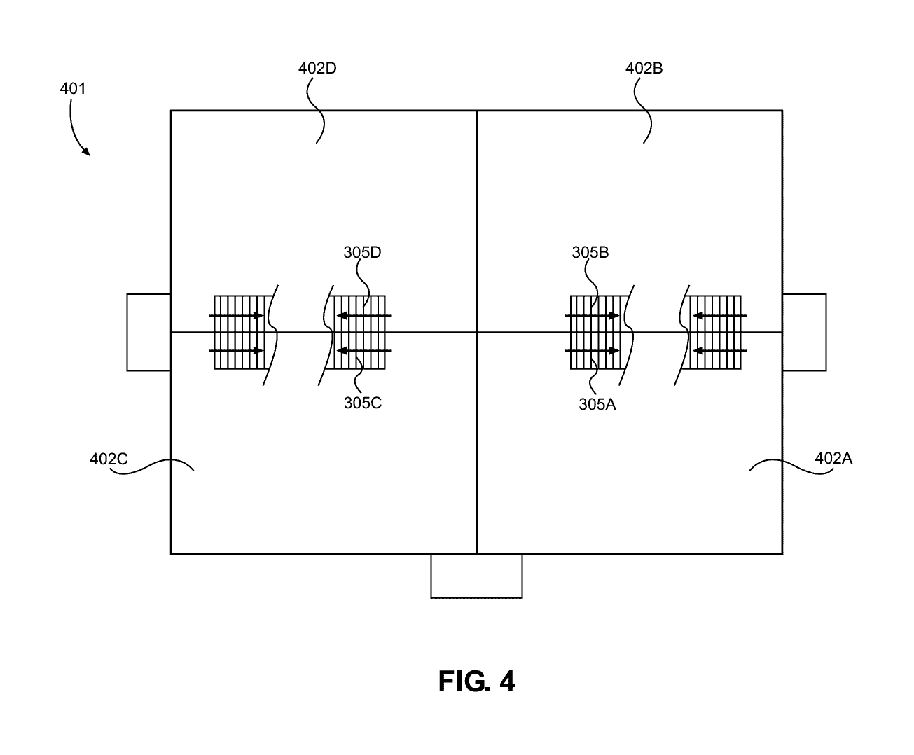

Referring now to FIGS. 3 and 4, there are shown plan views of the first and second floors of a diagram of an illustrative embodiment of the present multi-story building. In an illustrative embodiment of the present building, the first level 301 includes the first one-story unit 302A, the second one-story unit 302B, and the garage unit 303 arranged in a rectangular floor plan. The first level 301 further includes a first entry 304A positioned to provide access to the first one-story unit 302A and a first entry 304B positioned to provide access to the second one-story unit 302B. The first entry 304A and the second entry 304B each provide individualized access to the first one-story unit 302A and the second one-story unit 302B.

The first level 301 further includes a third entry 304C and a fourth entry 304D positioned adjacently next to each other between the first one-story unit 302A and the garage unit 303. The third entry 304C includes a first access way 305A configured to provide individualized entry to the first multi-story unit 402A. The fourth entry 304D further includes a second access way 305B configured to provide individualized entry to the second multi-story unit 402B. The first level 301 further includes a fifth entry 304E and a sixth entry 304F positioned adjacently next to each other between the second one-story unit 302B and the garage unit 303. The fifth entry 304E includes a third access way 305C configured to provide individualized entry to the third multi-story unit 402C. The sixth entry 304F further includes a fourth access way 305D configured to provide individualized entry to the fourth multi-story unit 402D. In the depicted embodiment of the present building, the access ways 305A, B, C, D are illustrated as stairways; however, the access ways 305A, B, C, D in other embodiments of the present building include elevators, lifts, and other mechanisms for obtaining entry to a higher level unit or structure.

In the embodiment of the present building depicted in FIG. 1, the multi-story units 402A, B, C, D are two stories in height. However, no claim is made as to a specific maximum height restriction for the multi-story units 402A, B, C, D. In alternative embodiments of the present building, the multi-story units 402A, B, C, D can be three or more stories in height. Furthermore, in the depicted embodiment of the present building the multi-story units 402A, B, C, D are depicted as symmetrical in shape in layout. However, no claim is made as to the multi-story units 402A, B, C, D being symmetrical in shape, size, or layout.

The depicted configuration of the present building gives each unit within the building its own individual access way, while still supporting a degree of population density that does not needlessly sacrifice living space. By providing each unit its own access way, there is no need for common access ways that are prohibitively expensive to construct and operate for the building owner. Furthermore, the tight, compact design of the building is convenient to reproduce and situate in complexes or neighborhoods.

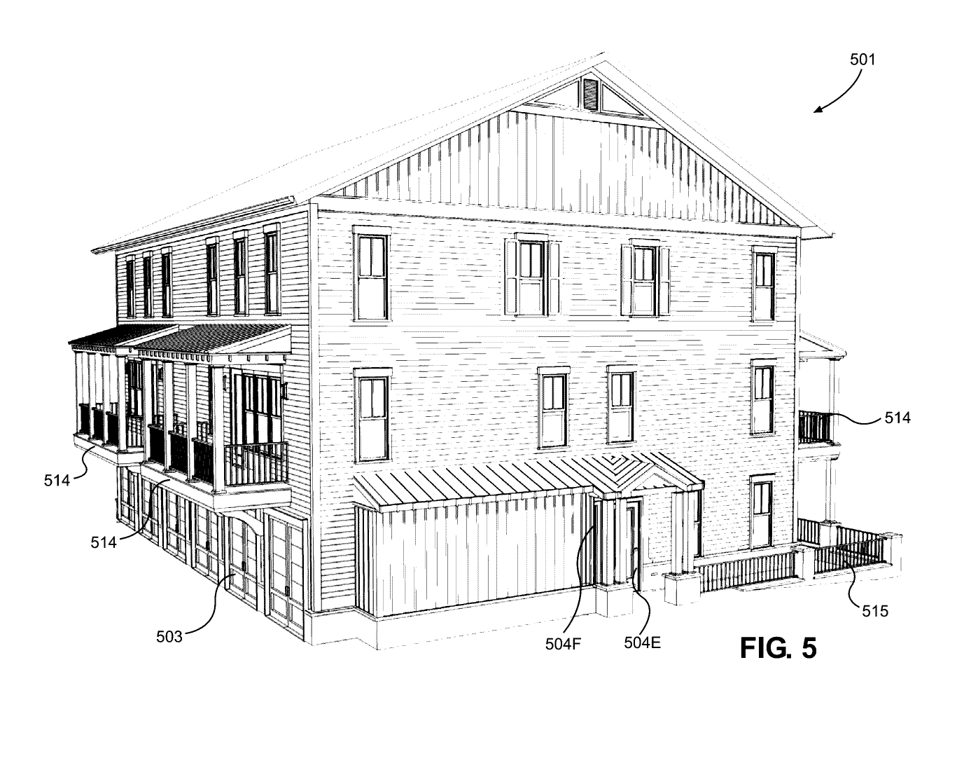

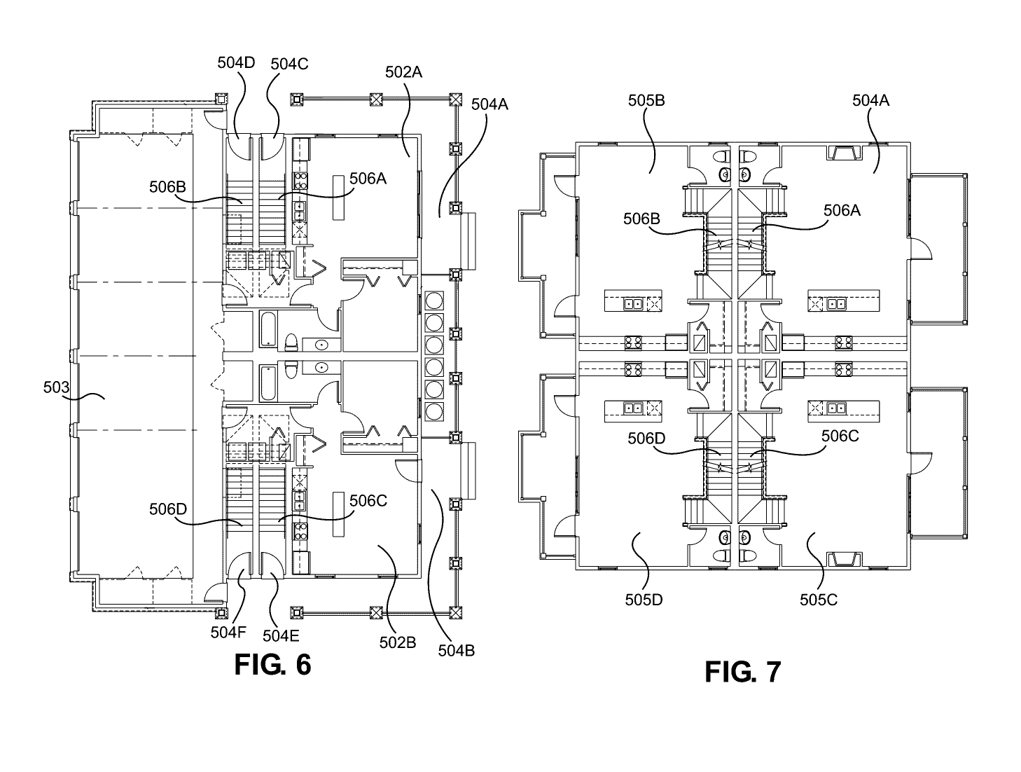

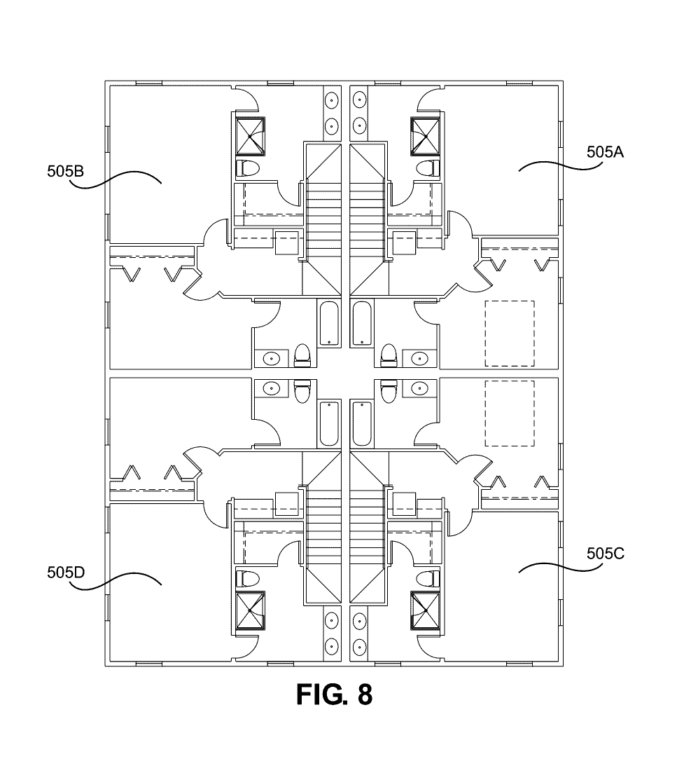

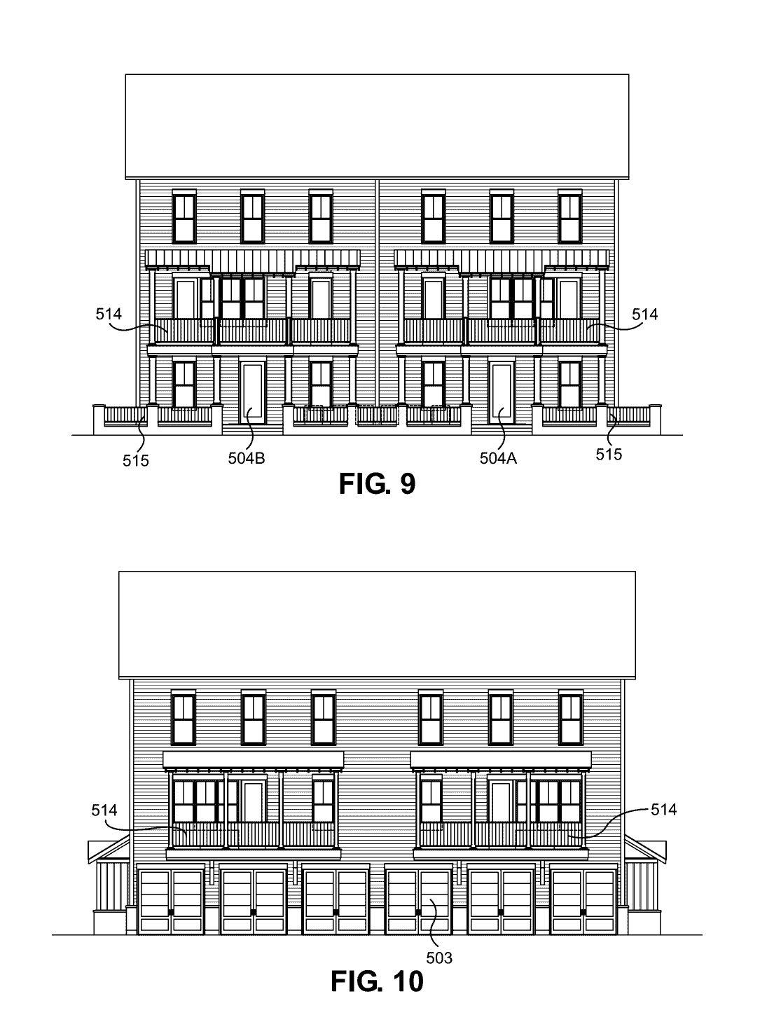

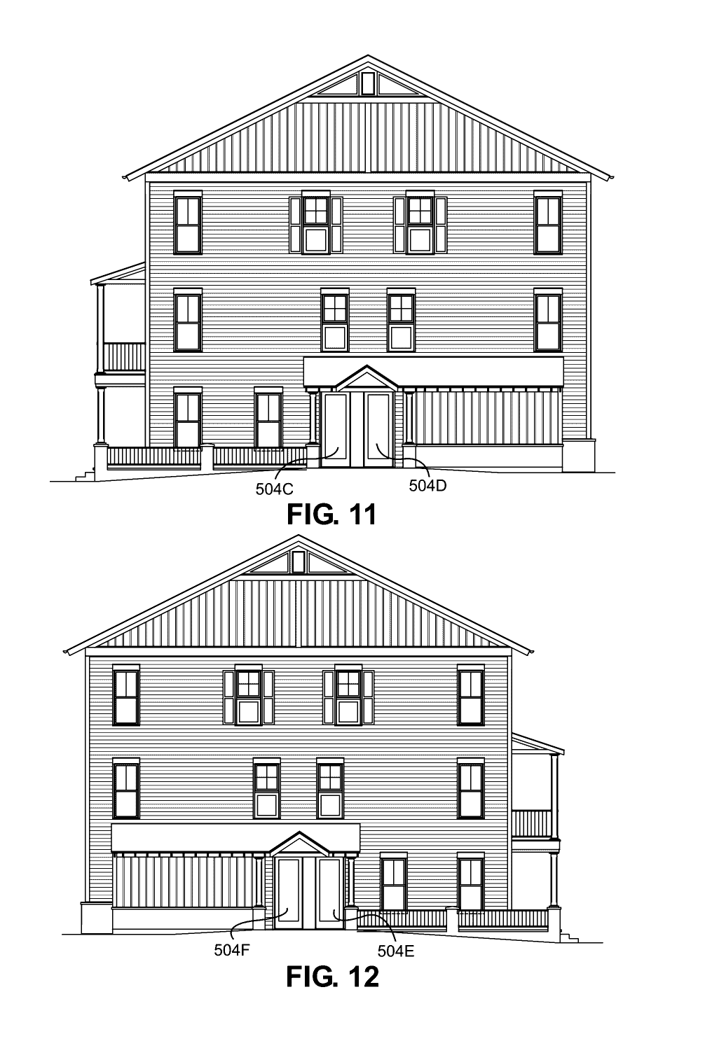

Referring now to FIGS. 5-12, there are shown perspective, plan, and elevational views of an embodiment of the present building. As in the aforementioned diagrams depicted in FIGS. 1-4, the present building 501 includes a garage unit 503, a first entry 504A that provides individualized access to a first single-story unit 502A, a second entry 504B that provides individualized access to a second single-story unit 502B, a third entry 504C that provides individualized access to a first multi-story unit 505A, a fourth entry 504D that provides individualized access to a second multi-story unit 505B, a fifth entry 504E that provides individualized access to a third multi-story unit 505C, and a sixth entry 504F that provides individualized access to a fourth multi-story unit 505D. The third entry 504C, the fourth entry 504D, the fifth entry 504E, and the sixth entry 504F include a first access way 506A, a second access way 506B, a third access way 506C, and a fourth access way 506D, respectively.

The illustrative embodiment of the present building 501 further includes a patio 515 disposed along the front exterior of the building 501 for each of the single-story units 502A, B and a balcony 514 disposed on the exterior of the building 501 for each of the multi-story units 505A, B, C, D. Each of the single-story units 502A, B and the multi-story units 505A, B, C, D further includes bathrooms, living rooms, kitchens, and other such amenities common to living spaces. Furthermore, in the depicted illustrative embodiment of the present building 501, each parking space of the garage unit 501 includes its own corresponding garage door.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A building, comprising:
a first one-story unit;
a second one-story unit;
a garage unit being one story in height;
the first one-story unit, the second one-story unit, and the garage unit defining a first level;
a first multi-story unit, a second multi-story unit, a third multi-story unit, and a fourth multi-story unit defining a second level, the second level situated above the first level;
a first entry positioned to provide access to the first one-story unit;
a second entry positioned to provide access to the second one-story unit;
a third entry including a first access way configured to provide entry to the first multi-story unit;
a fourth entry including a second access way configured to provide entry to the second multi-story unit;
the third entry and the fourth entry positioned between the first one-story unit and the garage unit;
a fifth entry including a third access way configured to provide entry to the third multi-story unit;
a sixth entry including a fourth access way configured to provide entry to the fourth multi-story unit; and
the fifth entry and the sixth entry positioned between the second one-story unit and the garage unit.

2) The building of claim 1, wherein the first level is arranged in a rectangular configuration and the second level is coextensive with the first level.

3) The building of claim 1, wherein at least one of the first access way, the second access way, the third access way, and the fourth access way is a stairway.

4) The building of claim 1, wherein at least one of the first access way, the second access way, the third access way, and the fourth access way is an elevator.

5) The building of claim 1, wherein the garage unit includes six parking spaces.

6) The building of claim 1, wherein each parking space of the garage unit includes an individual garage door.
